(19) United States
(12) Patent Application Publication
(10) Pub. No.: US 2013/0159091 A1
(43) Pub. Date: Jun. 20, 2013

(54) Hosted website access prompted by product

(71) Applicant: William Anthony Harper, Redmond, WA (US)

(72) Inventor: William Anthony Harper, Redmond, WA (US)

(21) Appl. No.: 13/385,233

(22) Filed: Feb. 9, 2012

Related U.S. Application Data
(60) Provisional application No. 61/630,800, filed on Dec. 19, 2011.

(51) Int. Cl. G06Q 30/02

(52) U.S. Cl. 705/14.41; 705/14.4

(57) ABSTRACT

Methods, processes, apparatuses and computer programs are described herein whereby the owner of a website has the website hosted by a hoster as host who provides the owner with product bearing the hosted website address. Public distribution of the product per a hoster allocation formula design prompts a product acquired by a recipient to access the hosted website in which products, services and agendas as content are displayed for consideration. Activities including ordering, manufacturing, allocating, accessing and others provide data that is recorded and analyzed by the hoster. Centralizing data collection by the host provides evaluation means and metrics to improve the time, nature and place to allocate product, the initial selection of product type itself, and even improve website content based on such empirical evidence of website success.

### RELATED APPLICATIONS

The present application is related to and claims the benefit of the earliest available effective filing date from the following application: Provisional application No. 61/630,800 filed 19 Dec. 2011 entitled “Hosted Website Access Prompted by Product”. Further, U.S. Pat. No. 7,966,217 entitled “Method for Packet Facilitated E-Commerce” and U.S. Pat. No. 8,027,875 entitled “Method for Measuring Packet Advertising Effectiveness” are herein incorporated by reference. All subject matter of the cited provisional application and issued patents are fully incorporated herein by reference to the extent such matter is not inconsistence herewith.

### FIELD OF THE INVENTION

The present invention generally relates to the field of enhancing the probability of website access by means of allocating products bearing the website address. Specifically, by centralizing data collection, such as website accesses by hosting many websites and correlating this data with other information in a knowledge base, meaningful patterns can be determined by which improved product allocation formulas are created for product selection, distribution and other useful designs applied to enhance improved website access as a means for obtaining of both ecommercial and esocial website objectives.

### BACKGROUND OF THE INVENTION

By 2007 there were an estimated 110 million distinct websites and some 30 billion web pages on the World Wide Web (Web) accessible through the Internet; these numbers continue to grow rapidly with each passing day. Every website has a unique web address technically known as a Uniform Resource Locator (URL) which appears as a string of routing numbers (e.g., 42.141.58.103). But such strings are difficult to recall so Internet users quickly developed a more mnemonic device known as domain names (e.g., www.example.com); such catchy domain name website addresses have become the public face of the URL so as to ease email correspondence and general access to websites. In the past decade entrepreneurs and other business-oriented individuals discovered and began development of the incredible commercial opportunities residing in Internet accessed websites where barriers to and costs for transacting business are virtually non-existent for the motivated buyer. Once connected, it often becomes only a matter of choice or travel as to what to buy online or at a referred place of business. In addition to ecommerce websites social websites have created their own sizable presents on the Web by providing social network linkages and advancing various social agendas, such websites used for a social purpose may be described as esocial websites as contrasted with ecommerce website even though both share the same general techniques, characteristics and even similar profit motives.

Entering an ecommerce website has become the virtual equivalent of going into a hardware store or restaurant; rarely does the buyer leave with nothing. This is particularly true if the website engages the buyer on a personal level with incentive or reward offerings in the form of effective, albeit virtual, marketeering. The real challenge facing business owners who have embraced ecommerce is getting the buyer to and through their virtual doorway, to their place of business by way of their web address. Esocial networking and agenda advocacy face similar challenges. Essentially, for both the business owner and social advocate, getting their needle of a website found in the haystack of the Web is the key factor. A marketing method that aids buyers and sellers in circumventing this haystack problem is disclosed in U.S. Pat. No. 7,966,217 entitled “Method for Packet Facilitated E-commerce” and U.S. Pat. No. 8,027,875 entitled “Method for Measuring Packet Advertising Effectiveness”.

However, another problem remains for the business owner who chooses to engage in ecommerce or the individual engaging in esocial networking or advocacy by direct product marketeering. It is a problem not unique to directly distributed products but shared by all forms of advertising and specifically a major concern of target marketing: how to fish out an interested party from the vast pool and bring that individual to and through the virtual doorway of the website to examine the offerings available within. To extend the analogy: what lure and its presentation attracts the bite. Whether the offering is a shirt, a plumbing service, or a political message the website content goes unrecognized, and worst—unheeded—if the interest party is simply unaware of its existence. The finest products and services go unnoticed and unsold if the business owner fails to effectively advertise; key relationships and vital agendas remain lost and unpersuasive absent an essential esocial connection. Accordingly, a technique to improve determining the who, what, when and where of product characteristics for a population where target marketing is possible would be useful. Specifically, a technique distributing product obtain by an order determined by an allocation formula derived from processed data of a knowledge base centrally collected by hosting the website accessed by website addresses borne by the allocated product and other sources. Further, the website owner (webstor) who relies upon the hoster hosting the website to provide valuable insight based on proprietary data and information centrally gained from numerous pertinent experiences and providing guidance on product selection during ordering and benefit of a best practices guidance allocation formula for product distribution has an improved probability of attaining a specific objective. Otherwise stated: what lure and presentation attracts the bite. Despite the considerable volume of prior art on the subject of ecommerce marketing there is still a significant need for such a straightforward tool for selecting and distributing webstor product utilizing such an allocation formula.

Examples of this prior art includes the afore cited patents to Harper (U.S. Pat. Nos. 7,966,217 and 8,027,875) where the use of hosted vendor websites provides a centralized means of collecting website access data prompted by the distribution of packets of liquid bearing the website address of the vendor. The first patent ('217) centers on providing an overview of the hosted website and its role in capturing access data prompted by distributed packets. The second patent ('875) is concerned with measuring the effectiveness of distributed packages in facilitating website ecommerce for the vendor as provided in reports and data to the vendor. Herein the focus is on the selection during ordering of the best-suited product or products meeting the objectives of the vendor (webstor) through a refinement of that choice by clarifying aspects of the order by an allocation formula taking into consideration aspects of the actual distribution of the product. Note the product for distribution herein is defined (see “Definitions and Explanations” following) as “any machine, article of manufacture and/or composition of matter”. Clearly included in this broad product definition is printed material such as advertisements in magazines that carry the vendor (webstor) website address in all manner of forms ranging from clear text to machine-readable matrix bar glyphs (e.g., QR code). An example of such art where marketing for ecommerce purposes are disclosed is U.S. Pat. No. 7,505,928 to Lebaschi, but therein is neither a hosted website disclosed nor a website access measurement taught. Another category of prior art in non-patent form is found in the marketplace. Various printing companies have expanded their conventional business enterprises to include hosting websites for customers who order various printed products such as business cards, brochures, calendars and similar materials. Representative companies of this type are Laurus Design (www.laurusdesign.ca), Kangaroo Print (www.kangarooprint.co.uk), and W Professionals (www.getursite.com). Yet in each of these operations, and the category they represent, none offer product access evaluation or any form of an allocation formula enhancement feature as part of the order process or anywhere else in their operations. The prior art supporting ecommerce and esocial activities via hosted websites does not yet offer a means whereby the older style of directive advertising represented by distributed physical products (e.g., matchbooks, pencils, Tagins packets, magazine ads) can successfully compete with the new virtual forms represented by search engine (e.g., Google, Bing) associative ads for directing traffic to websites.

### SUMMARY OF THE INVENTION

Methods, processes, apparatuses, programs and other computer-based techniques are described herein whereby the owner of a website has the website hosted by a hoster as host who aids in the selection of and provides the owner with product bearing the hosted website address. Public distribution of the product per a hoster allocation design prompts a recipient of an acquired product to access the hosted website in which products, services and agendas as content are displayed for consideration. Activities as steps such as order creation aided by an allocation formula, product manufacturing, product allocation, website accessing and others provide data and information which is recorded and analyzed by the hoster. These resources, and other information, created from the experience of other widely ranging allocations of products involving other hosted websites and their evaluations all contribute to providing reports on the effectiveness and demographic characteristics of allocated product driven access for both individual hosted websites and categories of same. Centralizing data collection by the host and creative manipulation by artificial intelligence techniques creates a data and information knowledge base capable of providing evaluation means and metrics to improve the time, nature and place to allocate product, the initial selection of product type itself, and even improve website content based on such empirical evidence of demonstrative website success. A successful website made possible by measurements derived from data collected and analyzed from centrally hosted websites in which the host provided allocated product bearing a website address prompting website access for consideration of that website content.

A key aspect of the present invention is that it offers the opportunity for small business to successfully compete with large corporations. Small business simply does not have the financial resources, time or skill to carefully gauge their market or successfully wage a strategic marketing campaign. All timely, useful and powerful tools for market research are the domain and often the property of the competing large corporation. By way of contrast, small business at best typically relies upon generalized marketing guidelines published in a monthly newsletter and hit-and-miss visceral trials hoping for good results before a market cycle passes by. Herein, however, a small business seeking to place a product order is coached by the order process which engages artificial intelligence to analyzing an extensive knowledge base of others experiences to recommend specific, customized best practices not only of what product to utilize but the circumstances it can best be allocated in and the experienced based effectiveness such a previous efforts have obtained. With continued use the feedback continually enlarges the knowledge base and producing better refinements and clarifications for current and future allocation formula designs to maximize the return for every marketing dollar spent. Further, the same information can be used to even adjust what the small business offers as website content. Through such a system as taught herein the small business has access to effective, highly customized marketing tools previously the exclusive domain of large corporation and through such access greatly levels the competitive field to their advantage.

By utilizing the systems taught herein a small business or even an individual has affordable access to the powerful resources of sophisticated computer systems powered by such as processors, software instructions, script sets, communication linkages, memory storages, data retrieval, knowledge bases, artificial intelligence techniques and complex analysis tools to name a few features populating today's expansive discipline of computer science and as such are employed herein. Computer science architects, designers, programmers, analysis and others meeting the definition of “one of ordinary skill in the art” who create systems as herein described use well-known techniques and tools taught in thousands of classes annually to craft the means for accomplishing each designated step and element as novelly disclosed by their inclusion, interaction and arrangement. An extensive “Definition and Explanations” section follows providing an understanding of the nature of the tools and techniques that are employed herein. Each inventive element and step herein, powered by well-known elements of complex computer system design, when arranged to provide the essential manner of this new invention, achieves results heretofore neither conceived of nor possible to accomplish.

Consequently, a primary objective of the present invention is to provide novel and significant advancement in the ecommerce and esocial arts by employment of an allocation formula that refines through use of computer reliant artificial intelligence techniques the ordering and distribution of product bearing a website address so as to prompt and/or facilitate hosted website access whereby favorable marketing metrics are realized.

Another object of the present invention is to create, maintain and use hoster held databases and information files populated with data derived from product ordering, manufacturing, distribution, website interactions and other associated sources of data and analysis as information in the form of a knowledge base.

Another object of the present invention is to create marketing systems whereby the competition for customers is equalized, where small businesses competing with large corporations have equal access to affordable, effective, sophisticated marketing tools.

Another object of the present invention is to have the hoster providing the webstor address bearing product and host and operate the webstor website accessed by that address whereby centralized databases and files containing relevant data and information are held by the hoster as proprietary property.

Another object of the present invention is to establish and describe the processor and instruction steps and other resources necessary to create means, apparatuses, processes, and/or procedures contributing to and sufficient for developing the techniques for product prompted centralized website access for ecommercial and esocial gain.

Another object of the present invention is to have the hoster furnish the webstor with reports analyzing data developed by determining allocation, manufacturing, distribution and website access activities prompted by product to communicate the effectiveness of allocated product as advertising media.

Another object of the present invention is to have the hoster furnish the webstor with reports analyzing data developed by determining allocation, manufacturing, distribution and website access activities prompted by product to communicate the demographic aspects of allocated product as advertising media.

A final object of the present invention is to use insight obtained from measured data analysis to continue, adjust, modify, and/or terminate all or any portion of the allocation formula, manufacturing specifications, distribution circumstances, and/or website content or form with the intent of improving the commercial or social benefit for either/or both the hoster and webstor through distributed product bearing a website address.

These and other objects and advantages of the present invention will become apparent from the following description taken in conjunction where appropriate with the accompanying diagram wherein are set forth, by way of illustrations and example, certain embodiments of this invention. The diagram constitute a part of this specification and include exemplary embodiments of the present invention and illustrate various objects and features thereof.

### BRIEF DESCRIPTION OF THE DRAWING

The invention will be better understood and even other objects than those set forth above will become apparent when consideration is given to the following detailed diagram showing the functional flow for the present invention:

FIG. 1 is a diagram showing the flow of functions between key components wherein product is ordered with input from an allocation formula, manufactured for the webstor by direction of the hoster of the webstor website, interaction with various hoster proprietary databases and information files, the product bearing the webstor website address distributed per the allocation directives into a population, and the product prompting access to the webstor website to examine the content therein to fulfill an interest in a product, service or agenda according to the teachings of the present invention taught herein.

### DETAILED DESCRIPTION OF THE INVENTION

### Definitions and Explanations

While the invention will be described in connection with illustrations, descriptions, and examples of preferred embodiments, it will be understood these are not intended to limit the present invention only to those embodiments. On the contrary, the present invention is to cover all structural and/or functional alternatives as generally described and defined by the appended claims, the various embodiments are merely provided to aid in teaching the new art and providing a degree of clarity by examples of the disclosed invention. The following explanations in parts I-VIII as follows provide definitions and guidance for interpreting the present application as invention and the subsequent embodiment discussions and claims.

### I. TERMS AND FUNCTIONS

The terms “a”, “an” and “the” mean “one or more”, unless expressly specified otherwise.

The term “accessing” and grammatical variants thereof (e.g., to access a website, a user accesses a website) means herein a successful Internet connection with the contents of a hosted website.

The term “artificial intelligence” and variations thereof means herein “a computer-based tool used to simulate creative problem solving as a useful aid to human decision making”, unless expressly specified otherwise. Herein one use of artificial intelligence is a construct of computer programs that employ the knowledge base systems represented by database data coupled with experienced based information file resources to provide various ranked options presented by the allocation formula. Artificial intelligence is not the simple retrieval and display of data. For example, artificial intelligence is not present by simply providing the call number of a library book in response to a subject query, that is merely echoing what was previously entered as a connecting subject tag. Artificial intelligence is demonstrated when the computer uses a knowledge base to make useful generalizations about the library holdings built on re-shelving patterns or constructs bibliographies on selected subjects after analyzing the bibliographic citation content of many high quality students papers. Artificial intelligence always has a palpable element of creative analysis characteristically involving data relational changes.

The term “allocation formula” and variations thereof means “allocation designs comprising elements of product, time, place and person for determining by artificial intelligence optimized selection and distribution of product”, unless expressly specified otherwise. Herein allocation formulas utilize programs or scripts (i.e., sets of computer instructions) formed by artificial intelligence and/or designs of such a system drawing upon a proprietary hoster knowledge base of information files and databases as a tool/service provided by a hoster, typically as part of the product order process initiated by the webstor, to optimize the order for access benefit and provide a distribution plan also to that end. These formulas are determined by means of computer instructions executed on one or more processors, functioning as artificial intelligence and expert systems, to provide enhanced problem solving whereby ecommerce and esocial concerns regarding website access by address bearing product are resolved. Distribution of product guided by an allocation formula plan as design is considered to allocate that product into a population. The experience based predictive modeling aspect of the hoster allocation formula effects, influences and/or customizes aspects of the order placed by the webstor and subsequent product distribution. For example, formula design scenarios contemplated may include what type and numbers of product to order, the when and where of product distribution provided as narratives and/or timetables, and to who as a specific group of people such allocation is directed; all forming elements that define an order capable of producing favorable market targeting metrics.

A reference to “another embodiment” in describing an embodiment does not imply that the referenced embodiment is mutually exclusive with another embodiment (e.g., an embodiment described before the referenced embodiment), unless expressly specified otherwise.

The phrases “at least one of” and “at least one”, when such phrases modifies a plurality of things (such as an enumerated or un-enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, is not intended to mean “one of each of” the plurality of things. Further, herein, the phrase indicates one or more individual thing of the plurality of things. For example, the phrase “at least one product” means one of more of any produce whether representatively listed or not.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The terms “comprising”, “including” and variations thereof means “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “demographic” and variations thereof means “statistical characterizing data useful for target marketing derived from attributes of a human population” as used herein, unless expressly specified otherwise.

The term “determining” and grammatical variants thereof (e.g., to determine a price, determining a value, determined by, determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database, file or another data structure), ascertaining and the like. Also, “determining” can include receiving (e.g., receiving information), accessing (e.g., accessing data in a memory) and the like. Also, “determining” can include calculating, comparing, computing, deriving, developing, establishing, estimating, processing, resolving and the like together with grammatical variants thereof. “Determining” does not imply certainty or absolute precision, and therefore “determining” can include estimating, extrapolating, predicting, guessing and the like. “Determining” does not imply that mathematical processing must be performed, and does not imply that numerical methods must be used, and does not imply that an algorithm or process is used unless specified. “Determining” does not imply that any particular device must be used; for example, a computer need not necessarily perform the determining unless specified by context.

The term “effectiveness” and variations thereof means “the attribution of a factor as cause providing a result”. Herein, the term connotes a comparative emphasis whereby plural datasets representing different circumstances concerning distributed address bearing product are examined for similar or divergent qualities. This examination produces a metric as a quantifiable result expressed as effectiveness. It does not typically mean a simple reporting of data without comparative analysis.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” and “a dataset” that the computer may send over the Internet. However, both “instructions” and “a data structure” are merely examples of “data”, and other things besides “instructions” and “a data structure” can be “data”.

The terms “embodiment”, “an embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The term “herein” means “in the present application, including anything which may be incorporated by reference”, unless expressly specified otherwise.

The term “hoster” and variations thereof (e.g., as host, xyz company hosts websites) simply means “an entity providing and/or using Web server resources facilitating website access”. Herein the meaning may include not only providing hosting for a webstor's website, but also providing the webstor a prompting product for distribution bearing website address, allocation planning during order processing, reporting effectiveness metrics for access prompts by distributed product to webstees, and other services. Herein this meaning further includes circumstances whereby hosting of a webstor website is performed by a party other than holder yet instructions and communication linkages provide the hoster with data and information typically provided by a hoster held website hosting operation and are thus fully the proprietary property of the hoster as data incorporated in hoster held databases and information files. Thus, even though the website is otherwise physically hosted, the effective hosting arrangement is considered the same and this alternative structure fully contemplated and encompassed herein in defining hoster hosting.

The term “hosting” and grammatical variants thereof (e.g., to host a website, a server computer hosts several websites) is used in an extremely broad sense as befitting the extensive technological complexity underlying the concept. Simply stated, without implying limitation, hosting “makes a website viewable and accessible on the World Wide Web by placing (hosting) it on an Internet connected Web server”. Since servers and supporting communication linkages are expensive to purchase and operate, proper maintenance complex and demanding, most website owners (webstors) pay Web hosting companies for use of hosting company resources—i.e., hosting the owner website. Website content is largely controlled by the owner, whereas website availability, connectivity, support services, and other various tools are provided on a fee-for-service basis by the Web hosting company.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term “invention” and the like terms mean “the one or more inventions disclosed in this application”, unless expressly specified otherwise.

The term “metric” and the like mean “one or more related data measurements that facilitates the quantification of some specified characteristic”, unless expressly specified otherwise.

The term “networking” and the like as used herein presents two aspects, commercial and social. Commercial is distinguished by various computer based ecommerce communication enterprises that stimulate commerce (e.g., advertising and promotion as practiced by Google and Amazon, a restaurant website). Social is characterized by individuals or groups establishing and maintaining Internet supported communication with one another for enhancement of their social agenda (e.g., Facebook, linking individuals with common interests). Just as the meaning and term “ecommerce” has come into common understanding and practice, the corollary term “esocial”, describing a comparable form of web-based social interaction, will find common usage in time. Herein, the commercial buyer and social individual are interchangeable entities accessing hosted websites as webstees. Thus, for example, the phrase “buyer with interest in a product or service” means the same as “person with an interest in a social connection”. The commercial buyer and social individual are the same, both are webstees, differentiated herein only by the object of their attention.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The term “plurality” means “two or more”, unless expressly specified otherwise.

The term “process” means any process, algorithm, method or the like, unless expressly specified otherwise. Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

The term “product” means any machine, article of manufacture and/or composition of matter, unless expressly specified otherwise.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “variation” of an invention means an embodiment of the invention, unless expressly specified otherwise.

The term “webstee” and variations thereof means “an entity which, as the recipient or beneficiary of a specific action, accesses the content of a hosted website”. For example, herein in a commercial transaction the webstee could be the person who accesses a website as an interested potential buyer. Herein in a social context the webstee could be a person who accesses a website to engage in social interaction or view agenda content. As to grammatical form the suffix usage is akin to “licensee” as descriptively employed in property law as contrasted with “licensor”.

The term “webstor” and variations thereof means “an entity which, as the owner of a website, has authority to govern its use and disposition”. For example, herein in a commercial transaction the webstor could be a seller of products and services who owns a website where such products and services are displayed as content and permits access to it by interested potential buyers. Herein in a social context the webstor could be a person who owns a website so as to engage in social interaction which advances some social agenda. As to grammatical form the suffix usage is akin to “licensor” as descriptively employed in property law as contrasted with “licensee”.

The term “website” means a collection of files and related resources, collectively described as content, organized as web pages on a Web server computer under a particular domain name and accessed as part of the World Wide Web (i.e., Web). On a commercial website content may be the offering of products and services; on a social website content may focus on social interests and agenda. Physically, website files and resources may be hosted on several Web servers in different locations.

The term “website address” means the domain name, URL, Internet Protocol (IP) address, and/or similar addressing nomenclature used to access websites on the Web (i.e., World Wide Web) via the Internet.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. FORMS OF SENTENCES

Where a limitation of a first claim would cover one of a feature as well as more than one of a feature (e.g., a limitation such as “at least one widget” covers one widget as well as more than one widget), and where in a second claim that depends on the first claim, the second claim uses a definite article like “the” or “said” to refer to the limitation (e.g., “the widget” or “said widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices that are described but are not explicitly described as having such functionality/features. Thus, other embodiments need not include the described device itself, but rather can include the one or more other devices which would, in those other embodiments, have such functionality/features.

### III. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. .sctn. 1.72(b).

The title of the present application and headings of sections provided in the present application are for convenience only, and are not to be taken as limiting the disclosure in any way.

Numerous embodiments are described in the present application (i.e., herein), and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, hardware, reporting, providing, determining and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application may constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiments are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality, unless specified otherwise.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### IV. COMPUTING

It will be readily apparent to one of ordinary skill in the art that the various processes described herein may be implemented by, e.g., appropriately programmed general purpose computers, special purpose computers, server computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. Additionally, a process may be an interlinked mixture of memory, processors and summary functions (e.g., hosting a website) that is also describable as an apparatus accomplishing one or more objectives.

Further, programs that implement such methods (as well as other types of data) may be stored and transmitted using a variety of media (e.g., computer-readable media, computer-readable medium) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The terms “computer-readable medium” and “machine-readable medium” refer to any medium, a plurality of the same, or a combination of different media, which participate in providing data (e.g., instructions, data structures, databases, information files) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media providing communication linkages include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium; a CD-ROM, DVD, any other optical medium; machine-readable matrix images code forms such as QR-code and bar codes; punch cards, paper tape, any other physical medium with patterns of holes; a RAM, a PROM, an EPROM, a FLASH-EEPROM; and any other memory chip or cartridge, a carrier wave as described hereinafter, or any other medium from which a computer can read.

Various forms of computer-readable media may be involved in carrying data (e.g. sequences of instructions) to a processor via communication linkages. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, TCP/IP, POST, TDMA, CDMA, 3G and 4G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements that are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases and information files are described, it will be understood by one of ordinary skill in the art that (i) alternative database and file structures to those described may be readily employed, and (ii) other memory structures besides databases and files may be readily employed. Any illustrations or descriptions of any sample databases and files presented herein are illustrative arrangements for stored representations of information. Any number of other arrangements may be employed besides those suggested by, e.g., tables illustrated in drawings or elsewhere. Similarly, any illustrated entries of the databases and files represent exemplary information only; one of ordinary skill in the art will understand that the number and content of the entries can be different from those described herein. Further, despite any suggestion or depiction of the files or databases as tables, other formats (including relational databases, heuristic forms, object-based models and/or distributed databases) could be used to store and manipulate the data types described herein. Likewise, object methods or behaviors of a database or file can be used to implement various processes, such as the described herein. In addition, the databases and files may, in a known manner, be stored locally or remotely from a device that accesses data in such a database and/or file. Data selectively drawn from databases and/or files for use in a specific process becomes processed data, a contributing component for determining the process product.

Various embodiments can be configured to work in a network environment including a computer that is in communication (e.g., via a communications network, a communication link) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel, Pentium or Centrino processor, that are adapted to communicate with the computer. Any number and type of devices may be in communication with the computer.

In an embodiment, a server computer or centralized authority may not be necessary or desirable, unless specified otherwise. For example, portions of the present invention may, in an expressed embodiment or otherwise, be practiced on one or more devices without a central authority. In such an embodiment, any functions described herein as performed by the server computer or data described as stored on the server computer may instead be performed by or stored on one or more such devices. However, central authority of the knowledge base is closely held by the hoster in all cases of distributed system functionality.

Where a process is described, in an embodiment the process may operate without any user intervention. In another embodiment, the process includes some human intervention (e.g., a step is performed by or with the assistance of a human).

### V. CONTINUING APPLICATIONS

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant may file additional applications to pursue patents for subject matter that has been disclosed and enabled but not claimed in the present application.

### VI. 35 U.S.C. .SCTN. 112, PARAGRAPH 6

In a claim, a limitation of the claim which includes the phrase “means for” or the phrase “step for” means that 35 U.S.C. .sctn. 112, paragraph 6, applies to that limitation.

In a claim, a limitation of the claim which does not include the phrase “means for” or the phrase “step for” means that 35 U.S.C. .sctn. 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. .sctn. 112, paragraph 6, applies to that step(s).

With respect to a means or a step for performing a specified function in accordance with 35 U.S.C. .sctn. 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. .sctn. 112, paragraph 6, structure corresponding to a specified function includes any product programmed to perform the specified function. Such structure includes programmed products that perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VII. DISCLAIMER

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### VIII. INCORPORATION BY REFERENCE

Any patent, patent application, other document or website fixed in time referred to herein is incorporated by reference into this patent application as part of the present disclosure, but only for purposes of written description and enablement in accordance with 35 U.S.C. .sctn. 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application unless they are specifically cited for inclusion by incorporation by reference herein.

### First Embodiment Example

### A Sandwich Shop

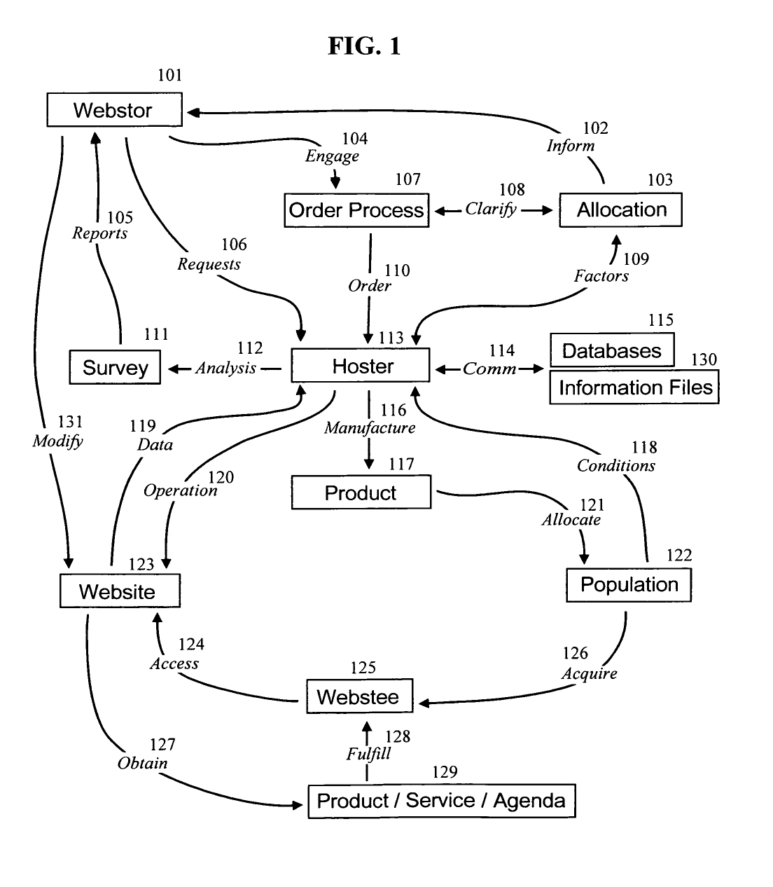

FIG. 1 provides a diagram showing the principle entities, actions and their interactions herein that begins with the webstor 101 engaging 104 in an order process 107 which will result in an order 110 for product being placed with the hoster 113. A key function represented in this portion of the schematic is the role performed by allocation 103 wherein an allocation formula determines by interaction with the webstor 101 the content of a product order 110 provided to the hoster 113. Herein execution of one or more executable instructions stored on a memory and executable on one or more processors, all control of and/or operated by and/or held by the hoster collectively as a computing and communication resource, manipulate and integrate data from both hoster 113 and webstor 101 sources to determine an optimum design for subsequent product 117 allocation 121. That this allocation formula determination is performed during the order process 107 reflects the need to consider those critical elements that comprise elements of allocation 121. Four elements in this mix may be characterized as product, time, place and person. Product selection may begin with the webstor 101 considering re-ordering another supply of a previously successful product 117. By way of example for this representative embodiment, the webstor 101 is the owner of a sandwich shop and the previous ordered product 117 is a fourfold card showing pictures and recipes for several of his offerings. Also the card as product 117 bears on its cover the website address of the owner's website 123, which is hosted by the hoster 113, where even more sandwich selections are offered as website content together with various services such as pre-ordering online for pickups and deliveries. The shop owner has found the cards (as product 117) produced a noticeable surge in both walk-in and website traffic and wants to maintain this and hopefully see further increases by distributing more cards. Hoster 113 analysis 112 as surveys 111 supplied as reports 105 provided to the webstor 101 (shop owner) has shown key relationships between the product 117 (recipe card) allocation 121 into a population 122 where a webstee 125 acquires 126 at least one of the product 117 and is prompted to access 124 the shop's website 123 by the website address the product 117 bears to obtain 127 the product/services 129 contained therein to fulfill 128 the webstee 125 desires. Important to this flow of activity is that all forms of data from the order 110 itself, through the manufacturing 116 specifications and product delivery, to feedback on the actual distribution conditions 118, to website accesses 124 and obtained 127 products/services/agendas 129 are all centrally collected by the hoster 113 and recorded in various proprietary databases 115 and/or information 130 files as a dynamic knowledge base held and manipulated by hoster 113 controlled artificial intelligence procedures for such activities as preparing product performance surveys 111 and order process 107 interaction 108 with the allocation 103 formula module. It is both the shop owner's impression of improved business and the facts presented by the reports 105 that has encouraged him to reorder more cards as product 117.

When the order process 107 is initiated 104 by the webstor 101 via a personal computer or similar tool capable of Internet interface, the order process 107 working with the allocation 103 module determines who and what the webstor 101 is, his past history and present needs, the reports 105 provided regarding previously allocated 121 product 117, all considered as factors 109 developed through communication 114 with the hoster 113 knowledge base established, maintained and held as dynamic databases 115 and information 130 files. Equipped with the assets of a centralized knowledge base resource (i.e., database 115 data and information 130 files) derived from numerous widely ranging experience based product allocations 121 for other webstor 101 efforts, their consequences and previous webstor experiences, the allocation 103 module employs techniques well known in the art of artificial intelligence and expert systems to clarify 108 and inform 102 the webstor through dialogue not only of the probable return benefit of more of the current product distribution (together with reorder numbers, timings of dispersal, recommended locations, and demographic population targets), but other alternative products that experience has found to have a high return benefit given the business characteristics and advertising pattern of the shop owner. For example, the allocation formula may rank a reorder of cards product 117 for a limited number of 1600 units to be distributed at two specific addresses, which are office buildings, during the morning arrival hour over four days so as to contact the staff employees working inside. Customized narrative summaries in case study formats provides experienced based insight to aid a selection decision. The formula also ranks high ordering 1000 units of Tagins packets of hand sanitizer product 117 bearing the shop name and website address for inclusion with each sandwich delivery to boast habit forming reorder recognition through repeated daily contact each time the recipient (webstee 125) cleans their hands. These Tagins packets assure attention saturation by incorporating the twin attributes of successful marketing, repetition and timeliness, which are not as effectively achieved by the cards themselves. Feedback on the campaign is provided by monitoring website 123 access 124 data 119 as reported to hoster 113 for inclusion in the knowledge base in the same manner as order data, as are the actual conditions 118 of product distribution to a population 122. Reports 105 on the campaign are provided as displays and/or prints in a timely manner to the webstor 101 by hoster 113 and irregular requests 106 for both standard and special surveys 111, analysis 112 and reports 105 can be made by the webstor 101 of the hoster 113. Included in the reports 105 provided to the webstor 101 are measurements as metrics determined by executing one or more executable instructions stored on a memory and executable on one or more processors and capable of gauging the effectiveness of the product 117 in prompting website access 124 expressed as one or more narratives, graphic and/or statistical representations providing one or more historical, current and/or predictive perspectives. With each order 110, product manufacturing 116, distribution 121, and website access 124 the ability of the process to sharpen its custom allocation 103 formula designs becomes keener thereby providing superior marketing tools at an affordable price to all forms and degrees of ecommerce and esocial enterprise.

Inherent to a successful website 123 is that the website content be easily and dynamically modified to best capture the interest of the webstee 125 and facilitate obtaining 127 the product/service/agenda 129 offered. As part of the website hosting arrangements establishing a business relationship between the webstor 101 and hoster 113 prior to first order placement, the hoster 101 provides to webstor 101 in computer-readable medium form for placement on memory in webstor machine, in parts as available through cloud application programmable interfaces or whole as available from a disk, an interface program to operate on a webstor 101 processor machine capable of executing this program and through internet communication with holster 113 and/or website 123, modify 131 by creating and/or changing the website content accessed 124 by the webstee 125. Also included in the interface program provided to operating on the webstor 101 processor is a module to facilitate formatting, selection and display the interchange dialogue tools necessary to completing an webstor order 110 conveyed to the hoster 113. Also included in the interface program to operate on the webstor processor as executed from memory is an instruction module containing tools to facilitate display and/or manipulation of various graphics and narratives provided as surveys 111 on effectiveness metrics derived from website access 124. The displayed metrics as data can be retained by the webstor 101 on memory for further personal evaluation and analysis. It is intended that the webstor 101 should employ the interface program under a conventional and customary end-user licensing agreement with the hoster 113.

### Second Embodiment Example

### An Election

While ecommerce dominates website traffic volumes today, esocial website traffic is rapidly growing and may exceed ecommerce as the major form of websites in the near future. Hosted website access prompted by product has as significant a networking role in marketing webstees to esocial websites with social agendas as it does in facilitating business on ecommerce websites. Another embodiment in which an esocial website uses various teachings herein would be to garner votes to elect a candidate to office. The money, time and effort directed to governance elections qualify it as a major industry in and of itself. Whether it is an election for high national office, moral persuasions trying to become law or a student running for a seat on the school council, there is a key issue for each—get the voter to a website to be influenced by message content. Targeting and customizing the means for prompting and/or facilitating a specific voter or category of voters to access a specific website with persuasive political content is a proven means of advancing an esocial agenda and winning elections.

Consider the mayor of a small town campaigning for reelection. As mayor she knows reelection will be difficult, she needs to attract both existing and new voters to her candidacy. She also knows two large blocks of people in town have historically not voted in community electrons. She has developed strong, persuasive website content for all the voters on one website and special emphasis for two additional website content keyed to the concerns of the elderly and apartment renters. At a recent conference of mayors she learned about the Holdst Corporation, a market targeting company providing a full service marketing setup which included hosting websites and access prompting by products bearing website addresses. She learned the company would not only coach her on what products could prove most effective in her campaign but would actually supply the product(s) selected and also provide an allocation formula design providing locations and target groups together with a schedule for product distribution and website release coordination. Most importantly, the company analyzes and promptly reports the effect of the product distribution on website access. That this reporting can be in near real-time allows the mayor to quickly change tactics as necessary to compound successes while curtailing underperforming efforts. She has a notebook the company distributed at the conference with their website address inside the front cover and is prompted to access their website for more information. The mayor finds the website persuasive, the service affordable and in discussion with her staff the consensus is to use the company in the upcoming election.

After setting up the website hosting arrangements, website page formats, security, coordination obligations, payment contract, downloading the interface program and similar tasks necessary to conducting a business relationship, the designated campaign staff member as webstor 101 engages 104 the Holdst system at the point of order process 107 wherein hoster 113 begins a process of executing one or more executable instructions stored on a memory and executable on one or more processors whereby the webstor 101 is guided through an expert system decision tree to ascertain who the webstor 101 is, what is the purpose of the order, when expressed in timetable, and quantifiable goals expected. This is accomplished by providing a series of choices and asking simple questions, periodically summarizing for the webstor 101 of the emerging draft profile with guidance on how to modify the profile to improve its accuracy. After construction of an acceptable profile a knowledge base represented by hoster databases 115 and information 130 files is mined for relevant information (e.g., similar small town elections, geographic locations, population demographics, cultural factors, results of same town campaigns) which is analyzed by computer programs such as inference engines producing a subset of information and data as critical conclusions further processed by allocation 103 formula programs which structure by artificial intelligence product recommendations that inform 102 the webstor 101 of ranked choices 117 to be allocated 121. Far more than just a simple numerical ranking or categorical groupings, these recommendations and designs may be comprised of explanations, backgrounds and justifications in the form of one or more narratives, graphics and/or statistical representations providing one or more historical, current and/or predictive perspectives. Together with recommended allocation 103 formula designs, determined by analyzing experience data and information minded from the knowledge base, which prescribes where, when and how to allocate the product 117 to a particular population 123, the webstor 101 is supplied with sufficient information to make a final informed determination and place an order 110 with the hoster 113. An event timetable supplied to the webstor 101 by the hoster 113 as part of the order process 107 also proves useful to the webstor 101 as they launch, modify 131 and remove website content on the website 123 under operational 120 control of the hoster 113.

Upon receipt of the order 110 the hoster 113 updates the knowledge base through communication 114 with the databases 115 and information 130 files and issues the necessary specifications and directives for the manufacture 116 of a product 117 bearing the website address of the designated webstor 101 website 123. In this instance of a mayoral reelection campaign the webstor 101 has chosen to establish three websites 123, each with persuasive emphasis on a different agenda and each with a separate website address. The first website has a form and content directed to the general electorate with persuasive content to match various competitor allegations and inadequacies in comparison to the mayor's record and plans. The second website has content directed to the concerns of the elderly by keying on past achievements like fighting to fund Medic One emergency care and a future goal of mandatory quarterly health and safety inspections of all retirement business properties. The third website has content directed to the concerns of apartment renters where under past achievements the website content describes the safety record achieved and considerable convenience provided by strict enforcement of snow and ice removal ordinances for clearing public areas of private property and a promise to create an arbitration office for renter/owner dispute resolution before either party hardens their stand. Both the second and third website also emphasize the important impact local government has on the quality of everyday life, how easy it is to vote, and provide a simply means to register by clicking right now to transfer to the official registration site so as to immediate begin the process. Key to making this approach of website electioneering work is getting the right voter 125 to the right website 123 to be persuaded by the appropriate agenda content. The products 117 ordered 110 are designed to accomplish this objective.

Based on the order process 107 guidance the webstor 101 has ordered 110 the following products, each bearing a website address, in appropriate numbers: printed notepads, Tagins sanitizers, Tagins scent lotions, magnetic frig stickers, and two styles of brochures. One type of brochures is in regular type and includes bar matrix glyphs for instance website 123 access 124 via smartphones; the second brochure is in larger type and boldface emphasis for web addresses. The allocation 103 formula design to allocate 121 the various products has identified several distribution means including door hanger bags, mailed packages, street distribution, gathering gifts, tables at community fairs and attendance at social invitationals. Custom allocation 121 designs may be highly customized. High value street locations and schedules have been specifically identified from analysis of public databases providing pedestrian concentration probabilities based on crosswalk data and information derived from previous allocation 121 designs known to the knowledge base. An example is a previous allocation formula done in this town by a restaurant seeking to boast its business specifically by attracting apartment dwellings for lunch and/or dinner. Feedback on that marketing effort, and specifically the reported conditions 118 of allocation (i.e., a red rose with a card attached bearing a matrix glyph that instantly connects the smartphone to the reservation website page) makes that particular design a rich vein of customized information for the mayoral reelection campaign. A second source of information proving particularly useful in developing the mayoral allocation design were a group of designs done in several other state where the recorded effectiveness data showed clear, measurable advantages of specific product 117 (e.g., scented lotions) allocated 121 in prescribed designs to specific population 122 with concentrations of certain webstee 125 age and ethnicity. Use of olfactory branding has significant extension benefit for spreading the electioneering message far beyond the primary contact. With the schedule of product 117 delivery dates in hand and the final revisions to the website 123 underway, the webstor 101 begins to organize and train the campaign's volunteers to conduct the allocation. Part of this training is how to observe, record and report the conditions 118 of the actual distribution (allocate 121) into the population 122. These conditions 118 of distribution are reported 105 to the webstor 101 as they occur so as to monitor the performance of the volunteers in such a manner as to make timely adjustments as necessary.

When acquired 126 by the webstees 125 the various products 117 immediately begin to prompt access 124 to the various websites 123 where content is viewed in varying degrees. A common technique in evaluating website effectiveness is creating a tree of linked pages as limbs and leaves that become more specific in the content they provide. By collecting data on the path followed, options chosen or not and dwell time per page analysis can make surprisingly accurate determinations on what content is more persuasive than others on the website 123, and how this content measures up to the metrics of the comparable allocation formula designs. Some products bore unique and/or group identifier codes that aid in determining who (webstee 125) is accessing 124 the website 123. One technique of embedded identifier code is in bar matrix glyphs like QR-code where embedded code, together with other information, is transmitted when the smartphone reads, links to and accesses 124 the designated website 123. Such transmissions are a rich source of data 119 captured by the hoster 113 for inclusion in the associated databases 115 and information 130 files, adding to the knowledge base they collectively represent as data and information memory. Executing one or more instructions stored on a memory and executable on one or more processor to determine a metric to quantify a demographic for a webstee 125 accessing 124 a hosted website 123 as easily made from such data as provided by smartphones usage, and the metric can be significantly enhanced by combining plural information from other uses and sources. As the products 117 were distributed (allocated 121) per the allocation 103 formula, data 119 was centrally collected by hoster 113 and communicated 114 to the databases 115 and information 130 files and subsequently analyzed 112 and reported 105 to the webstor 101, it becomes apparent the campaign strategy was working. Not only were the websites 123 showing strong curve profile matches with previous high return designs on primary accesses 124 with good dwell times and high frequency page chainings, but there were strong secondary and tertiary waves of access 124. Hoped for registration queries and actual registrations out-links were also very strongly indicated. Boasted by the initial campaign the mayor followed up with a second campaign at the same time the mail-in ballets were distributed with a “get out and vote” theme with website content to match. The target groups of retirees and apartment renters voted in record numbers and overwhelming for the mayor as shown by public registration records and district voting returns. She won handily and is now considering a run for a higher state office.

It is to be understood that even though numerous characteristics and advantages of the present invention have been set forth in the foregoing description, together with details of the structure, function, and employment of the invention, the disclosures are illustrative only, and changes may be made in details, especially in matters of shape, size, and arrangement of the parts together with content and materials and form utilized, within the principles of the invention to the full extent indicated by the broad general meaning of the terms are expressed. In particular, the foregoing specification and embodiments are intended to be illustrative and are not to be taken as limiting. Thus, alternatives, such as functional equivalents, and other such modifications will become apparent to those skilled in the art upon reading the foregoing description. Many different arrangements of the various components depicted, as well as components not shown, are possible without departing from the scope of the claims below. Two specific embodiments of the subject technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility, may be employed without reference to other features and sub-combinations, and are contemplated within the scope of the claims.

1. A networking process, comprising steps of:
executing one or more executable instruction stored on a memory and executable on one or more processor to create an order determined by a hoster allocation formula by which hoster provides webstor with at least one product bearing said webstor website address;
hosting a website of said webstor by said hoster of said product whereby said website content is accessible by said address borne by said product;
distributing per a said allocation formula said product in a population including one or more webstee with interest in said content offered by said webstor;
accessing said webstor website by said website address by said webstee possessing at least one of said product by which said website address prompts and/or facilitates said access to consider said content described on said webstor website; and,
executing one or more executable instructions stored on a memory and executable on one or more processor to determine a metric quantifying the effectiveness of distributed product to prompt access to hosted website.

2. The process of claim 1 further comprising the steps of recording data derived from executing said order in databases and information files established, maintained and held by the hoster of said product; and, recording data derived from said accessing of said webstor website in databases and information files established, maintained and held by the hoster of said product.

3. The process of claim 1 further comprising the step of associating an identifier code with said product.

4. The process of claim 1 further comprising the step of executing one or more executable instruction stored on a memory and executable on one or more processor to determine a metric to quantify a demographic for said webstee accessing said hosted website.

5. The process of claim 1 wherein analysis of said metric comprises one or more narratives, graphics and/or statistical representations providing one or more historical, current and/or predictive perspectives reported to said webstor by said hoster.

6. The process of claim 1 wherein said website address is borne within and/or on said product.

7. The process of claim 1 wherein said distribution includes reporting actual conditions of said distribution into a population to hoster for inclusion in databases and/or information files.

8. A networking apparatus, comprising:
means for executing one or more executable instruction stored on a memory and executable on one or more processor to create an order with a hoster, developed with a hoster allocation formula, which provides webstor with at least one product bearing said webstor website address for distribution;
means for hosting a website of said webstor by said hoster whereby said website content is accessible by said address borne by said product; and,
means for executing one or more executable instructions stored on a memory and executable on one or more processor by which hoster determines by use of the hoster knowledge bases and reports to webstor a metric quantifying the effectiveness of distributed product prompting access to hosted website.

9. The apparatus of claim 8 further comprising:
means for distributing per hoster provided allocation formula said product in a population including one or more webstee interested in content offered by said webstor; and, means for accessing said webstor website at said website address by said webstee possessing at least one of said product by which said website address prompts and/or facilitates said access to consider said content offered on said webstor website.

10. The apparatus of claim 9 wherein said website address is borne within and/or on said product.

11. The apparatus of claim 9 further comprising means for executing one or more executable instruction stored on a memory and executable on one or more processor to determine a metric that quantifies a demographic for said webstee accessing said hosted website.

12. The apparatus of claim 8 further comprising means for including an identifier code borne by said product.

13. The apparatus of claim 8 further comprising means for recording data derived from said order process in databases and information files established, maintained and held by the hoster of said product.

14. The apparatus of claim 8 further comprising means for recording data derived from said accessing said webstor website in databases and information files established, maintained and held by the hoster of said product.

15. A website hosting apparatus, comprising:
A machine-readable medium comprising one or more instruction that when executed by one or more hardware processors in a machine, the instructions cause at least one hardware processor in said machine to:
process a webstor order to a hoster using an allocation formula by which hoster obtains for webstor at least one product for distribution bearing said webstor website address;
provide from hoster to webstor an allocation formula design regarding distributing said product;
operate a webstor website hosted by said hoster so that said website content is accessible by said address borne by said product and such access data and information is recorded in hoster held knowledge base comprising databases and information files; and,
determine by use of said knowledge base a metric that quantifies the effectiveness of distributed product to prompt access to hosted website.

16. A computer-readable medium tangibly embodying an interface program of computer executable instructions for use on a webstor held computer, the program instructions comprising:
one or more executable instruction stored on a memory and executable on one or more processors to place a webstor order derived from an allocation formula with a hoster to obtain at least one product for allocation bearing said webstor website address;
one or more executable instruction stored on a memory and executable on one or more processors to create and/or modify content of a webstor website hosted by said hoster accessible by said website address; and,
one or more executable instruction stored on a memory and executable on one or more processors to display and/or retain a metric quantifying the effectiveness of distributed product prompting access to hosted website.

17. A computer-readable medium tangibly embodying a hoster held program of computer executable instructions and executed on one or more processors in a machine, the program instructions comprising:
one or more executable instruction stored on a memory and executable on one or more processors to manipulate hoster databases and/or information files as a knowledge base derived from an allocation formula and/or accesses of a webstor website hosted by a hoster prompted by at least one allocated product provided by hoster bearing said webstor website address with intent to create, modify, examine and/or record parts of said knowledge base thereby creating at least one new dataset capable of determining a metric that quantifies the effectiveness of distributed product prompting access to hosted website.

18. A computer-readable medium tangibly embodying a program of computer executable instructions and executed on one or more processors in a machine, the program instructions comprising:
one or more instruction capable of manipulating hoster databases and information files as a knowledge base derived from allocation formula determinations and/or accesses of a webstor website hosted by a hoster prompted by at least one allocated product provided by hoster bearing said webstor website address with intent to create, modify, examine and/or record parts of said knowledge base whereby one of more allocation formula designs for selecting and distributing said products is created by said hoster for said webstor.

19. One or more processor readable storage devices having processor readable code embodied on said processor readable storage devices, said processor readable code for programming one or more processors to perform a method for ordering a product employing an allocation formula designs that facilitates hosted website access, the method comprising the steps of:
creating a hoster order using an allocation formula by which hoster provides webstor with at least one distributable product bearing a webstor website address;
hosting said webstor website by said hoster accessible by said product address; and,
entering data and information developed by said providing and said accessing into a hoster knowledge base comprised of databases and information files.

20. The method of claim 19 further comprising the step of hoster measuring said website access for effect by said distributed product per said allocation formula.

21. A computer program product capable of administrating a website hosting company functioning as hoster, the computer program product comprising a computer-readable medium encoded with computer-executable instructions for executing an algorithm on one or more processors in a machine comprising:
the website hosting company processing a webstor order per said instructions determined by an allocation formula providing at least one distributable product bearing said webstor website address;
the website hosting company hosting in one or more Web servers a website of said webstor whereby website content is accessible by said address borne by said product; and,
the website hosting company determining one or more metrics that quantify the effectiveness of distributed product prompting access to hosted website.

22. The computer program product of claim 21 further comprising the website hosting company recording data derived from executing said order in databases and information files established, maintained and/or held by the website hosting company; and, recording data derived from accesses of said webstor website in databases and information files established, maintained and/or held by the website hosting company.

23. The computer program product of claim 21 further comprising the website hosting company executing one or more executable instruction stored on a memory and executable on one or more processor to determine a metric quantifying the demography of accesses to said hosted website.

24. The computer program product of claim 21 wherein said website hosting company has an economic objective in quantifying said hosted website access prompted by said product.
